(19) United States
(12) Patent Application Publication
(10) Pub. No.: US 2006/0170854 A1
(43) Pub. Date: Aug. 3, 2006

(54) Liquid crystal display and method of fabricating the same

(75) Inventors: Hye-rhee Han, Gyeonggi-do (KR); Jong-woong Chang, Gyeonggi-do (KR); Yeong-keun Kwon, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/341,020

(22) Filed: Jan. 27, 2006

(30) Foreign Application Priority Data
Feb. 1, 2005 (KR) 10-2005-0008994
May 24, 2005 (KR) 10-2005-0043492

(51) Int. Cl. G02F 1/1339

(52) U.S. Cl. 349/153

(57) ABSTRACT

The present invention relates to an LCD that has a first panel, a second panel, a sealant, and a liquid crystal layer between the two panels. The first panel includes a pad provided in a first part of a non-display region and a dummy metal pattern provided in a second part of the non-display region along a circumference of a display region. The second panel is positioned opposite the first panel so that the two panels sandwich the liquid crystal layer. A sealant is formed on the pad and the dummy metal pattern and couples the first panel with the second panel. Thus, an LCD described herein has a uniform cell gap. A method of fabricating an LCD that has a uniform cell gap is also disclosed.

### CROSS-REFERENCE TO RELATED APPLICATIONS

This application claims the benefit of Korean Patent Application No. 2005-0008994 filed on Feb. 1, 2005 and Korean Patent Application No. 2005-0043492 filed on May 24, 2005 in the Korean Intellectual Property Office, the disclosures of which are incorporated herein by reference.

### BACKGROUND OF THE INVENTION

1. Field of the Invention

The present invention relates to a liquid crystal display (LCD) and a method of fabricating the same.

2. Description of the Related Art

A liquid crystal display (LCD), which has been widely used as a display, includes an LCD panel. The LCD panel controls the light transmissivity of individual liquid crystal cells based on a video signal. As the liquid crystal cells are arranged in a matrix configuration, the desired image is displayed by controlling the liquid crystal cells' light transmissivities.

The LCD panel comprises a thin film transistor (TFT) array panel, a color filter array panel coupled to the TFT array panel, and a liquid crystal layer sandwiched between the TFT array panel and the color filter array panel. Further, polarizing plates are attached to the outsides of the TFT array panel and the color filter array panel.

The TFT array panel and the color filter array panel are usually coupled by a sealant applied along the circumference of a display region. The sealant not only couples the TFT array panel with the color filter array panel but also forms a cell gap for the LCD. However, the circumferential thickness of the display region formed in the TFT array panel, to which the sealant is applied, varies according to the presence or absence of a pad for connecting the TFT array panel to a driving circuit. Thus, the thickness of the sealant is not uniform, and the cell gap of the LCD is irregular.

The optical properties of the LCD is closely related with the cell gap for the liquid crystal layer sandwiched between the TFT array panel and the color filter array panel. Particularly, the optical properties such as a contrast and a view angle of the LCD are varied depending on the product of the double refraction Δn of the liquid crystal layer and the distance of the cell gap. Therefore, when the cell gap of the LCD is not uniform, the optical properties of the LCD are also not uniform.

### SUMMARY OF THE INVENTION

An aspect of the present invention is an LCD that has a uniform cell gap.

Another aspect of the present invention is a method of fabricating an LCD that has a uniform cell gap.

Additional aspects and/or advantages of the invention will be set forth in part in the description which follows and, in part, will be obvious from the description, or may be learned by practice of the invention.

The foregoing and/or other aspects of the present invention can be achieved by providing an LCD including a first panel and a second panel that are coupled with a sealant and a liquid crystal layer between the two panels. The first panel includes a pad provided in a first part of a non-display region and a dummy metal pattern provided in a second part of the non-display region along a circumference of a display region. The sealant is formed on the pad and the dummy metal pattern.

The sealant may include a spacer including plastics. For example, the sealant may include a spacer that is deformed by 5% or more in a direction of a force when the force of about 500 kg/mm² is applied to the spacer at a room temperature.

The dummy metal pattern may have a width wider than the width of the sealant.

The dummy metal pattern may include a plurality of dots, which may be arranged in five or more rows. The distance between the dots may range from about 5 μm to about 15 μm.

Some of the dots may have either a circular cross-section or a polygonal cross-section.

Some of the dots may have a diameter ranging from about 15 μm to about 40 μm.

The dots may be arranged to have a density ranging from 40% to 60%.

The second panel may include an outer black matrix arranged along the sealant.

The dummy metal pattern may be a line pattern arranged parallel to the circumference of the display region. Alternatively, the dummy metal pattern may include a line pattern arranged at a predetermined angle to the circumference of the display region.

The pad may include a gate pad and a data pad, and the dummy metal pattern may be formed of the same layer as either the gate pad or the data pad.

The LCD panel may also include a signal line that is at least partially placed inside the dummy metal pattern.

The pad may include a gate pad and a data pad, the dummy metal pattern may include a first dummy metal pattern across the display region from the gate pad, and a second dummy metal pattern across the display region from the data pad, and the signal line may be partially placed inside the first dummy metal pattern.

The first panel may include a gate line and a data line arranged at an angle relative to each other and insulated from each other, and the signal line is insulated from and positioned at an angle with respect to the data line.

The signal line may include a repair line.

In another aspect, the invention includes an LCD panel including a first panel that has a display region defined by a gate line and a data line; a second panel opposite the first panel; a sealant formed along a circumference of the display region and coupling the first panel with the second panel; a liquid crystal layer provided between the first panel and the second panel; and a dummy metal pattern provided on either the first panel or the second panel and uniformizing the height of the sealant.

In yet another aspect, the invention is a method of fabricating an LCD panel, comprising providing a first panel comprising a pad provided in a first part of a non-display region and a dummy metal pattern provided in a second part of the non-display region along a circumference of a display region; providing a second panel; forming a sealant on either the first panel or the second panel along the pad and the dummy metal pattern; and filling liquid crystal between the first panel and the second panel and coupling the first panel with the second panel.

The pad may include a gate pad, and the dummy metal pattern may be formed in the same process step as the gate pad.

The pad may include a data pad, and the dummy metal pattern is formed at the same time when the data pad is formed.

The dummy metal pattern may include dots.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a configuration of an LCD according to a first embodiment of the present invention;

FIG. 2 is a sectional view of the LCD, taken along the line II-II of FIG. 1;

FIG. 3 is a sectional view of the LCD, taken along the line III-III of FIG. 1;

FIG. 4 is a sectional view of the LCD, taken along the line IV-IV of FIG. 1;

FIG. 5 is a view illustrating an electrostatic phenomenon arising in a dummy metal pattern;

FIG. 6 is a sectional view of an LCD according to a second embodiment of the present invention;

FIG. 7 is a configuration of an LCD according to a third embodiment of the present invention;

FIG. 8 is a configuration of an LCD according to a fourth embodiment of the present invention;

FIG. 9 is a configuration of an LCD according to a fifth embodiment of the present invention;

FIG. 10 is a sectional view of the LCD, taken along the line X-X of FIG. 9;

FIG. 11 is a view of a dummy metal pattern according to a sixth embodiment of the present invention;

FIG. 12 is a view of a dummy metal pattern according to a seventh embodiment of the present invention;

FIG. 13 is a view of a dummy metal pattern according to an eighth embodiment of the present invention;

FIG. 14 is a view of a dummy metal pattern according to a ninth embodiment of the present invention;

FIG. 15 is a configuration of an LCD according to a tenth embodiment of the present invention;

FIG. 16 is a configuration showing the relationship between a dummy metal pattern and a repair line in the LCD according to the tenth embodiment of the present invention;

FIG. 17 is a sectional view of the LCD, taken along the line XVII-XVII of FIG. 15; and

FIG. 18 is a view illustrating an electrostatic phenomenon arising in the dummy metal pattern in the LCD according to the tenth embodiment of the present invention.

### DETAILED DESCRIPTION OF EMBODIMENTS

Reference will now be made to the embodiments of the present invention, examples of which are illustrated in the accompanying drawings in which like reference numerals refer to like elements throughout. The embodiments are described below by referring to the figures.

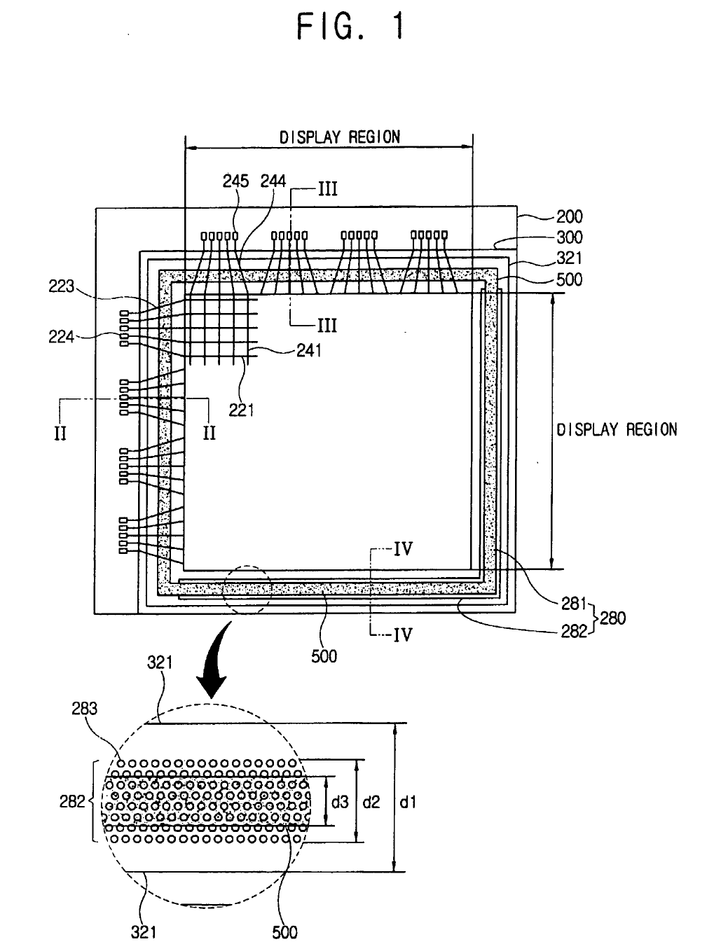

Hereinbelow, an LCD according to a first embodiment of the present invention will be described with references to FIGS. 1 through 4.

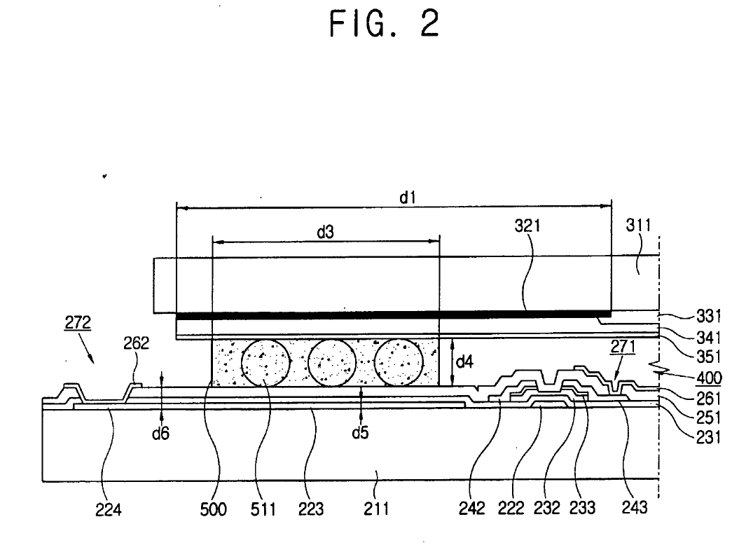

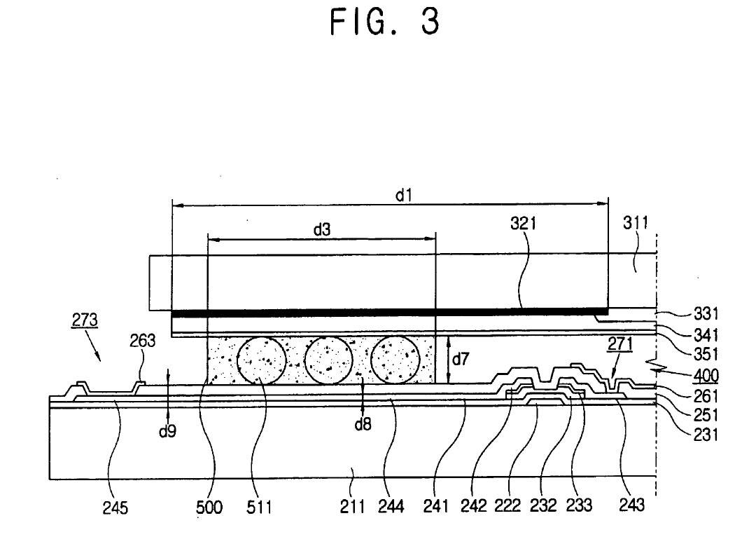

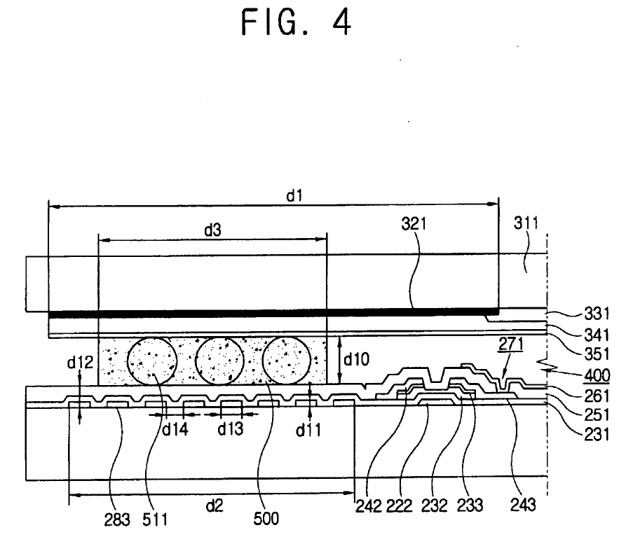

FIG. 1 is a configuration of an LCD according to the first embodiment of the present invention; FIG. 2 is a sectional view of the LCD taken along the line II-II of FIG. 1; FIG. 3 is a sectional view of the LCD taken along the line III-III of FIG. 1; and FIG. 4 is a sectional view of the LCD taken along the line IV-IV of FIG. 1.

The LCD includes a first panel 200 formed with a plurality of TFTs, a second panel 300 opposite to the first panel 200, a sealant 500 coupling the first panel 200 with the second panel 300, and a liquid crystal layer 400 sandwiched between the first and second panels 200 and 300.

The first panel 200 is as follows.

A first insulating plate 211 is made of an insulating material such as glass, quartz, plastic or the like. On the first insulating plate 211 are formed a gate line 221, a gate electrode 222, a gate fan out 223, and a gate pad 224, which are herein collectively referred to as “gate wiring lines.” A plurality of gate lines 221 are arranged parallel to each other to extend in a first direction; the gate electrode 222 is connected to the gate line 221; the gate fan out 223 extends from the gate line 221; and the gate pad 224 is connected to the gate fan out 223 and receives a driving signal from a driving circuit (not shown). In the embodiment shown, the gate fan out 223 and the gate pad 224 are placed in a non-display region outside a display region.

On the first insulating plate 211 and the gate wiring lines 221, 222, 223, 224 is formed a gate insulating layer 231 made of silicon nitride SiNx or the like. On the gate insulating layer 231 deposited in the region corresponding to the gate electrode 222 are formed a semiconductor layer 232 made of amorphous silicon and a resistive contact layer 233 made of n+ amorphous silicon hydride that is highly doped with n-type impurities. The resistive contact layer 233 is bifurcated with respect to the gate electrode 222.

On the resistive contact layer 233 and the gate insulating layer 231 are formed data lines 241, a source electrode 242, a drain electrode 243, a data fan out 244, and a data pad 245, which are herein collectively referred to as “data wiring lines.” The data lines 241 are arranged in a second direction that is substantially perpendicular to the first direction and define a pixel by intersecting the gate lines 221; the source electrode 242 partially branch from the data line 241 and extend to a top portion of the resistive contact layer 233; the drain electrode 243 is separated from the source electrode 242 and formed opposite to the source electrode 242 with respect to the gate electrode 222; the data fan out 244 extend from the data line 241; and a data pad 245 is connected with the data fan out 244. In the embodiment shown, the data pad part 244, 245 is placed in the non-display region outside the display region.

Thus, the gate pad part 223, 244 and the data pad part 244, 245 are placed in a first part of the non-display region. No gate pad part 223, 224 or data pad part 244, 245 is placed in a second part of the non-display region. In the second part of the non-display region, a dummy metal pattern 281, 282 is formed along the circumference of the display region. The dummy metal pattern 281, 282 includes a first dummy metal pattern 281 that is across the display region from the gate pad part 223, 224 and a second dummy metal pattern 282 that is across the display region from the data pad part 224, 245. According to the first embodiment of the present invention, the dummy metal pattern 281, 282 is made of the same material as the gate wiring lines 221, 222, 223, 224. That is, the dummy metal pattern 281, 282 and the gate wiring lines 221, 222, 223, 224 are formed in a single step in a fabricating process. Here, the dummy metal pattern 281, 282 is formed to match the height of the gate pad part 223, 224 and the data pad part 244, 245.

The dummy metal pattern 281, 282 includes a plurality of dots 283. The dots 283 are arranged to form a plurality of lines. Preferably, the dots 283 are arranged in five or more rows in order to prevent static electricity from being introduced in the display region, as will be described in more detail. Although the dot 283 is shown to have a circular-shaped cross-section in the embodiment, this is not a limitation of the invention. For example, the dot 283 may have a polygonal-shaped cross-section such as an octagonal shaped section or the like in another embodiment. In one embodiment, the distance d14 (See FIG. 4) between the dots 283 ranges from 5 μm to 15 μm, and the diameter of the dot 283 ranges from 5 μm to 40 μm. Additionally, the dots 283 are arranged such that the dots 283 in the neighboring rows are staggered, thus increasing the overall dot density. Preferably, the density of the dots 283 is similar to those of the gate fan out 223 and the data fan out 244. The dots 283 may have a density of 40% through 60%.

A passivation layer 251 is formed on the data wiring lines 241, 242, 243, 244, 245 and the semiconductor layer 232, which are not covered with the data wiring lines 241, 242, 243, 244, 245. The passivation layer 251 may be made of silicon nitride. In the embodiment shown, the passivation layer 251 may be made of silicon nitride or an organic layer. The passivation layer 251 is formed with contact holes 271, 272, 273 through which the drain electrode 243, the gate pad 224 and the drain pad 245, respectively, are exposed. Further, the gate insulating layer 231 is removed corresponding to the contact hole 271 to expose the gate pad 224 therethrough.

On the passivation layer 251 are formed transparent electrodes 261, 262, 263. The transparent electrodes 261, 262, 263 are made of a transparent conductive material such as indium tin oxide, indium zinc oxide or the like. Here, the transparent electrodes 261, 262, 263 comprise a pixel electrode 261 electrically contacting the drain electrode 243 through the contact hole 271, and the contact member 262, 263 contacting the gate and drain pads 224 and 245 via the contact holes 272, 273, respectively. Further, the pixel electrode 261 applies voltage from the drain electrode 243 to the liquid crystal layer, thereby adjusting the arrangement of liquid crystals.

Now, the second panel will be described.

The second panel 300 includes a second insulating plate 311 made of an insulating material such as glass, quartz, ceramic, plastic, etc. like the first insulating plate, an outer black matrix 321 formed along the circumference of the second insulating plate 311, a trichromatic color filter 331 having a set of red, green and blue or a set of cyan, magenta and yellow, an overcoat layer 341 formed on the color filter 331, and a common electrode 351 formed on the overcoat layer 341.

The outer black matrix 321 distinguishes the display region from the non-display region. Here, the outer black matrix 321 can be made of chrome, chrome oxide, chrome nitride or a multi-layered metal including a combination thereof. Further, the outer black matrix 321 can be made of a photosensitive organic material including a black color pigment to intercept light, wherein the black color pigment includes carbon black, titanium oxide or the like.

The color filter 331 is formed by repeating the sets of red, green and blue or the sets of cyan, magenta and yellow. The color filter 331 colors the light that passes through the liquid crystal layer 400. The color filter 231 can be made of a colored photosensitive organic material by a well-known pigment dispersion method.

The overcoat layer 341, which is used to protect the color filter 331, is made of an acrylic epoxy material.

The common electrode 351 is made of a transparent conductive material such as indium tin oxide (ITO), indium zinc oxide (IZO) or the like. Here, the common electrode 351, together with the pixel electrode 261 of the first panel 200, directly applies a signal voltage to the liquid crystal layer 400.

Under the outer black matrix 321 is provided the sealant 500 coupling the first panel 200 with the second panel 300. The sealant 500 includes an acrylic resin, an epoxy resin or the like, and is hardened by ultraviolet rays and/or heat. Further, the sealant 500 additionally includes an amic hardener, a filler such as alumina powder, etc. Inside the sealant 500 is provided a spacer 511 made of plastic such as the acrylic resin. The spacer 511 may be made of a plastic coated with silica. When a force of about 500 kg/mm² is applied to the spacer 511 at a room temperature, the “soft” characteristic of the plastic allows the length of the spacer 511 to be preferably deformed by 5% or more in a direction of the force. The spacer 511 is employed for maintaining the cell gap between the first and second panels 200 and 300. Further, when the sealant 500 is formed on a circuit fabricated on the first panel 200, the spacer 511 prevents the circuit from being damaged. In some embodiments, the sealant 500 may be provided with a “hard” spacer made of glass fiber or silica to maintain the cell gap between the first and second panels 200 and 300. A “hard” spacer does not deform under pressure like the “soft” spacer made of plastic.

The sealant 500 is placed within a region corresponding to the outer black matrix 321. In general, the outer black matrix 321 has a width d1 ranging from about 3 mm to 5 mm, and the sealant 500 has a width d3 that is about 0.7 mm to 2 mm narrower than the width d1 of the outer black matrix 321. Referring to FIG. 1, the sealant 500 placed to the left side of the display region is formed on the gate fan out 223, and the sealant 500 placed at the top side of the display region is formed on the data fan out 244. Further, the sealant 500 placed to the right and bottom sides of the display region are formed on the dummy metal patterns 281 and 282, respectively.

The sealant 500 formed on the gate fan out 223 will be described with reference to FIG. 2. In a region corresponding to the sealant 500, the gate fan out 223, the gate insulating layer 231 and the passivation layer 251 are layered on the first panel 200 in sequence to a predetermined thickness d6. Further, in the region corresponding to the sealant 500, the outer black matrix 321, the overcoat layer 341 and the common electrode 351 are layered on the second panel 300 in sequence. Thus, the sealant 500 is placed between the passivation layer 251 and the common electrode 351. Alternatively, the common electrode 351 may be not be placed in the region corresponding to the sealant 500.

The sealant 500 formed on the data fan out 244 will be described with reference to FIG. 3. In a region corresponding to the sealant 500, the gate insulating layer 231, the data fan out 244 and the passivation layer 251 are layered on the first panel 200 in sequence to a predetermined thickness d9. Further, in the region corresponding to the sealant 500, the outer black matrix 321, the overcoat layer 341 and the common electrode 351 are layered on the second panel 300 in sequence. Thus, the sealant 500 is placed between the passivation layer 251 and the common electrode 351. In some alternate embodiments, the common electrode 351 may be placed outside the region corresponding to the sealant 500.

The sealant 500 formed on the second dummy metal pattern 282 will be described with reference to FIG. 4. Likewise, the sealant 500 formed on the first dummy metal pattern 282 has the same structure as that of FIG. 4, and therefore repetitive descriptions will be avoided. In a region corresponding to the sealant 500, the dots 283 of the second dummy metal pattern 282, the gate insulating layer 231 and the passivation layer 251 are layered on the first panel 200 in sequence to a predetermined thickness d12. Further, in the region corresponding to the sealant 500, the outer black matrix 321, the overcoat layer 341 and the common electrode 351 are layered on the second panel 300 in sequence. Thus, the sealant 500 is placed between the passivation layer 251 and the common electrode 351. Alternatively, the common electrode 351 may be placed in a region other than the region corresponding to the sealant 500. Here, each width d2 of the dummy metal patterns 281 and 282 is narrower than the width d1 of the outer black matrix 321 and wider than the width d3 of the sealant 400. Thus, the sealant 400 is formed within the region corresponding to the dummy metal pattern 281, 282.

Thus, the cell gaps d4, d7 and d10 are substantially equal to each other according to the arrangement of the sealant 500. For example, the cell gaps d4, d7 and d10 range between 4.5 μm and 5 μm. Therefore, the distances d6, d9 and d12 between the sealant 500 and the first insulating plate 211 should be substantially equal to each other. Referring to FIGS. 2 through 4, the distances between the sealant 500 and the second insulating plate 311 are also substantially equal to each other. Further, the gate insulating layer 231 and the passivation layer 251 are commonly provided between the sealant 500 and the first insulating plate 211. Therefore, the gate fan out 223, the data fan out 244 and the dots 283 should be equal to each other in the thickness d5, d8, d11. Here, the gate fan out 223 and the dots 283 are made as the same layer, so that they are equal to each other in the thickness d5, d11. Further, the thickness d5 of the gate fan out 223 is similar to the thickness d8 of the data fan out 244. For example, the thickness d5, d8 ranges from 2,000 Å to 2,500 Å. The cell gaps d4, d7 and d10 are substantially equal to each other regardless of their positions.

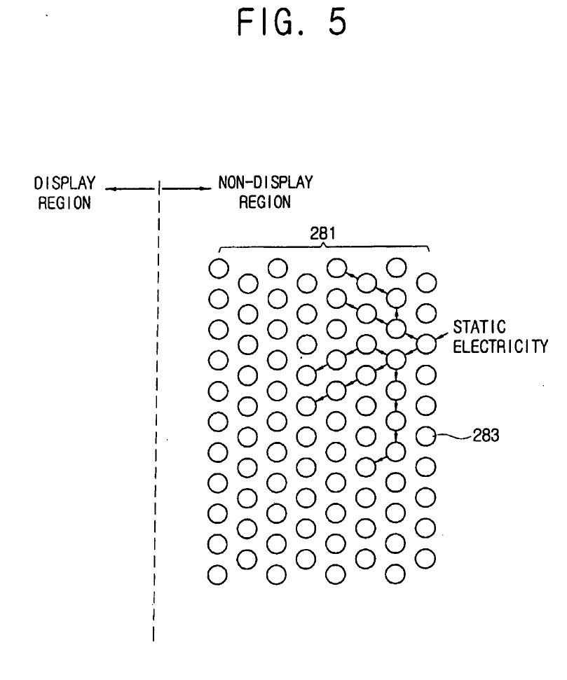

FIG. 5 is a view illustrating an electrostatic phenomenon arising in a dummy metal pattern. External static electricity may be applied to the dots 283 of the dummy metal pattern 281, 282. The static electricity is transferred to the neighboring dots 283. Thus, the static electricity is dispersed through many dots 283 and dissipates, so that it is not transferred to the display region. Typically, it takes about five rows of the dots 283 for the static electricity to dissipate. Thus, it is preferable to arrange the dots 283 in five or more lines. Further, the distance d14 between the dots 283 is set to allow the the electrons to hop therebetween. Thus, the dummy metal pattern 281, 282 is formed in a dot shape, thereby preventing the external static electricity from intruding into the display region.

Hereinbelow, a method of fabricating the LCD according to the first embodiment of the present invention will be described.

In the first panel 200, a gate wiring material is deposited and patterned on the first insulating plate 211, thereby forming the gate wiring lines 221, 222, 223, 224 and the dummy metal pattern 281, 282. The following process is the same as a process of fabricating a well-known TFT array panel. Further, the second panel 200 can be fabricated by a well-known method.

Thereafter, the sealant 500 including the spacer 511 is applied to the second panel 300. The sealant 500 can be applied with a dispenser method or a printer (screen printing) method. The sealants 500 are formed to locate on the gate fan out 223, the data fan out 244, the first dummy metal pattern 281, and the second dummy metal pattern 282, respectively, when they adhere to the first panel 200. Then, liquid crystal is filled between the second panel 300 and the sealant 500 by a dropping method. Thereafter, the first panel 200 and the second panel 300 are coupled, and the sealant 500 is hardened by heat and/or ultraviolet rays.

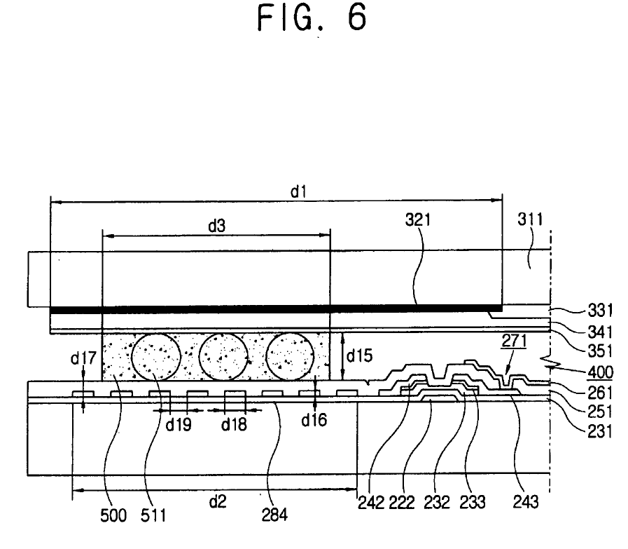

FIG. 6 is a sectional view of an LCD according to a second embodiment of the present invention.

In a region corresponding to a sealant 500, a gate insulating layer 231, a dot 284 of a second dummy metal pattern 282 and a passivation layer 251 are layered on a first panel 200 in sequence to a predetermined thickness d17. Further, in a region corresponding to the sealant 500, an outer black matrix 321, an overcoat layer 341 and a common electrode 351 are layered on a second panel 300 in sequence. Thus, the sealant 500 is placed between the passivation layer 251 and the common electrode 351. In some alternative embodiments, the common electrode 351 may be placed in an area other than the region corresponding to the sealant 500. Here, the dot 284 is made of the same material as the data fan out 244, wherein the thickness d16 of the dot 284 is equal to the thickness of the data fan out 244. Therefore, the cell gap d15 corresponding to the second dummy metal pattern 282 is substantially equal to the other cell gaps d4, d7. Further, the diameter d18 of the dot 284 and the distance d19 between the dots 284 are the same as those of the dot 283 according to the first embodiment.

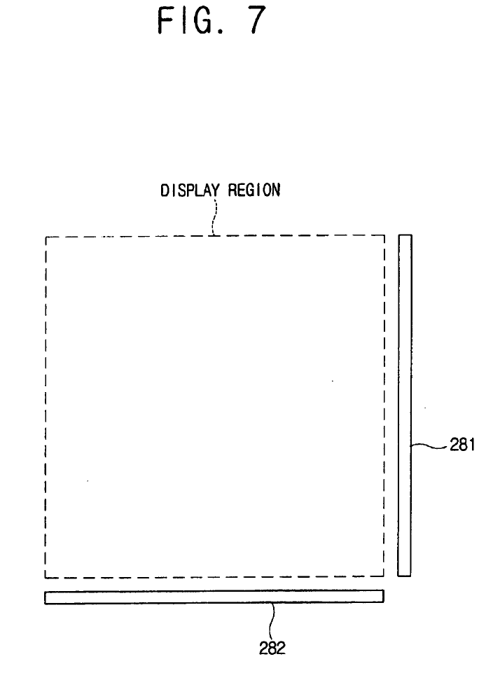

FIG. 7 is a configuration of an LCD according to a third embodiment of the present invention. According to the third embodiment of the present invention, a first dummy metal pattern 281 and a second dummy metal pattern 282 are separated from each other.

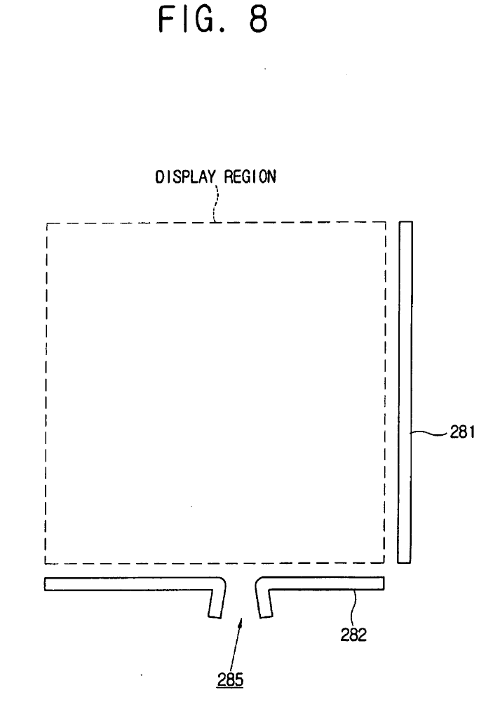

FIG. 8 is a configuration of an LCD according to a fourth embodiment of the present invention. According to the fourth embodiment of the present invention, a second dummy metal pattern 282 is formed with an inlet 285. Similar to the first embodiment, a sealant 500 is formed on a second panel 300. The sealants 500 are formed to locate on a gate fan out 223, a data fan out 244, a first dummy metal pattern 281, and a second dummy metal pattern 282, respectively, when they adhere to the first panel 200. Therefore, the sealant 500 is shaped corresponding to the second dummy metal pattern 282 formed with the inlet 285. Thereafter, the first panel 200 and the second panel 300 are aligned and adhered to each other, and the sealant 500 is hardened by heat and/or ultraviolet rays. In this state, liquid crystal is filled between the first and second panels 200 and 300 through the inlet 285 by a vacuum filling method. After the liquid crystal is completely filled between the panels 200 and 300, the inlet 285 is sealed by a sealant to be hardened by violet rays.

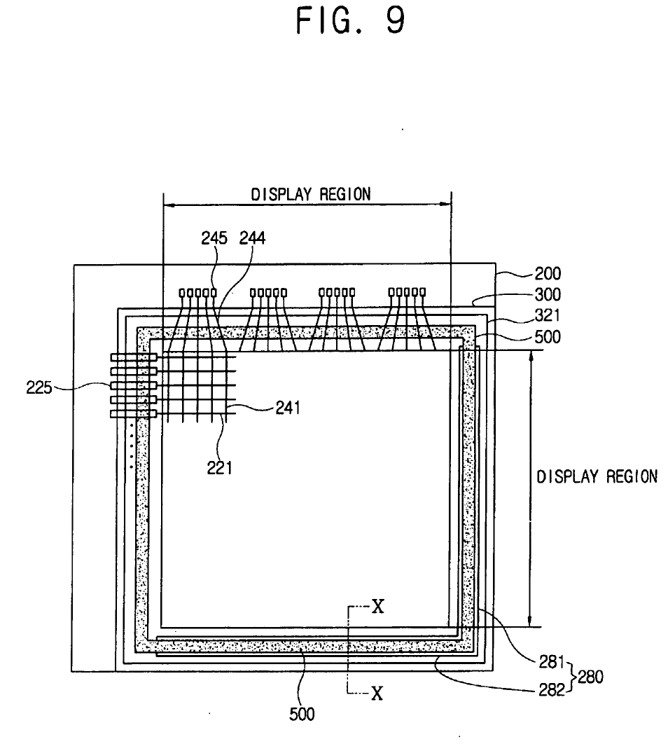

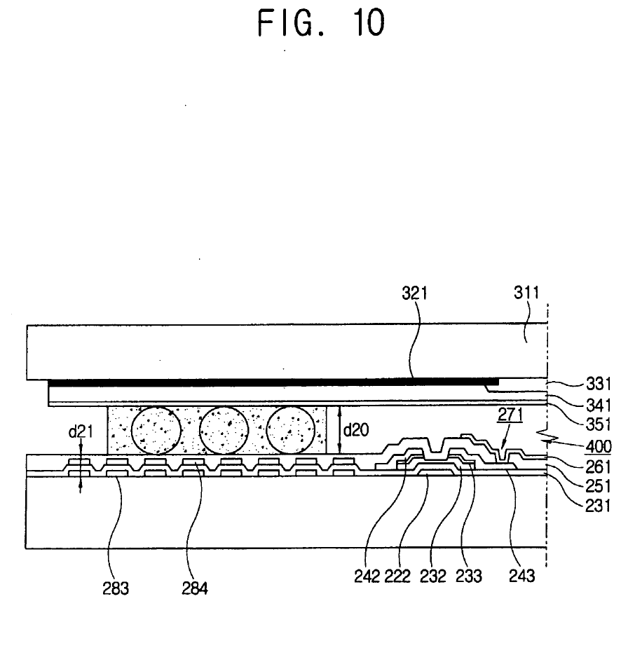

FIG. 9 is a configuration of an LCD according to a fifth embodiment of the present invention, and FIG. 10 is a sectional view of the LCD, taken along line X-X of FIG. 9.

According to the fifth embodiment contrary to the first embodiment, there is no gate pad part, and a gate line 221 is connected to a shift register 225 provided in the outside of the display region. That is, a driving circuit for driving the gate line 22 is directly provided in a first panel 200. The sealant 500 placed in the left side of the display region is formed on the shift register 225, wherein the shift register 225 includes a plurality of thin film transistors, so that the shift register 225 is thicker than the gate fan out 223 of the first embodiment.

Referring to FIG. 10, a dot 283, a gate insulating layer 231, a dot 284 and a passivation layer 251 are sequentially layered between the sealant 500 and a first insulating plate 211, thereby forming a predetermined thickness d21. Here, the lower dot 283 is made of the same material as a gate wiring material, and the upper dot 284 is made of the same material as a data wiring material. Because of the lower and upper dots 283 and 284, the distance between the sealant 500 and the first insulating plate 211 is larger than the distances d6, d9 and d12 of the first embodiment to account for the thickness difference between the shift register 225 and the gate fan out 223. Thus, the cell gap d20 in this position is smaller than the cell gaps d4, d7 and d10 according to the first embodiment.

According to an embodiment of the present invention, the dummy metal patterns 281 and 282 are not limited to the dot shape and may have various shapes, which will be described later with reference to the first dummy metal pattern by way of example.

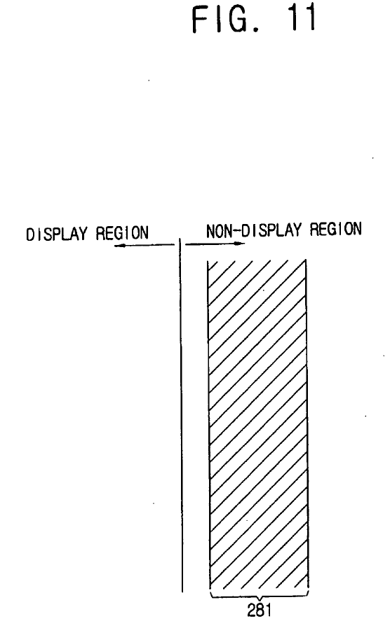

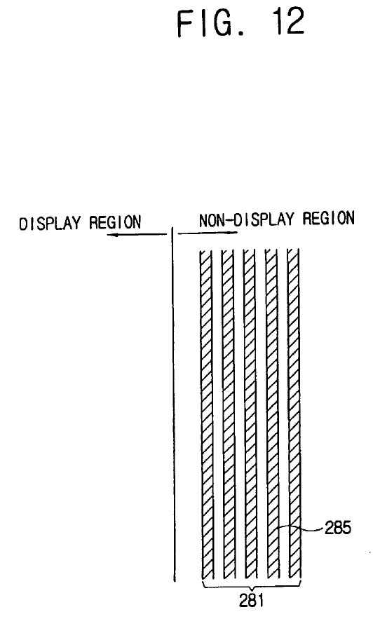

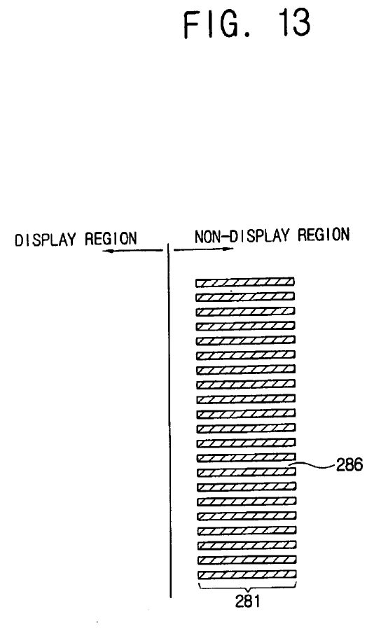

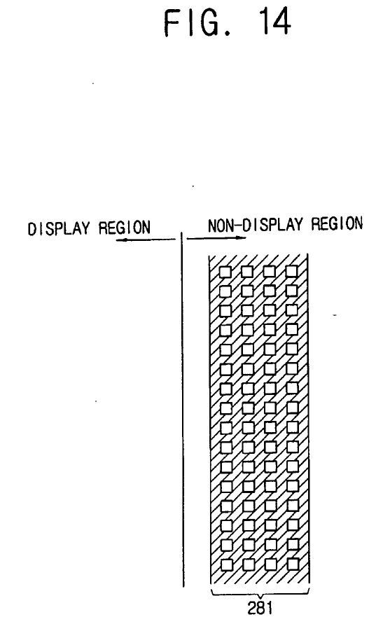

FIGS. 11 through 14 are views of the dummy metal patterns according to sixth through ninth embodiment of the present invention. Referring to FIG. 11, the first dummy metal pattern 281 according to the sixth embodiment has a single solid shape. Referring to FIG. 12, the first dummy metal pattern 281 according to the seventh embodiment is shaped into a plurality of lines 285 arranged parallel to the circumference of a display region. Referring to FIG. 13, a first dummy metal pattern 281 according to the eighth embodiment has a plurality of lines 286 arranged perpendicularly to the circumference of the display region. Referring to FIG. 14, a first dummy metal pattern 281 according to the ninth embodiment has a lattice shape as a combination of the parallel lines 285 and the perpendicular lines 286.

Alternatively, the line patterns 285 and 286 may be arranged at various angles to the circumference of the display region.

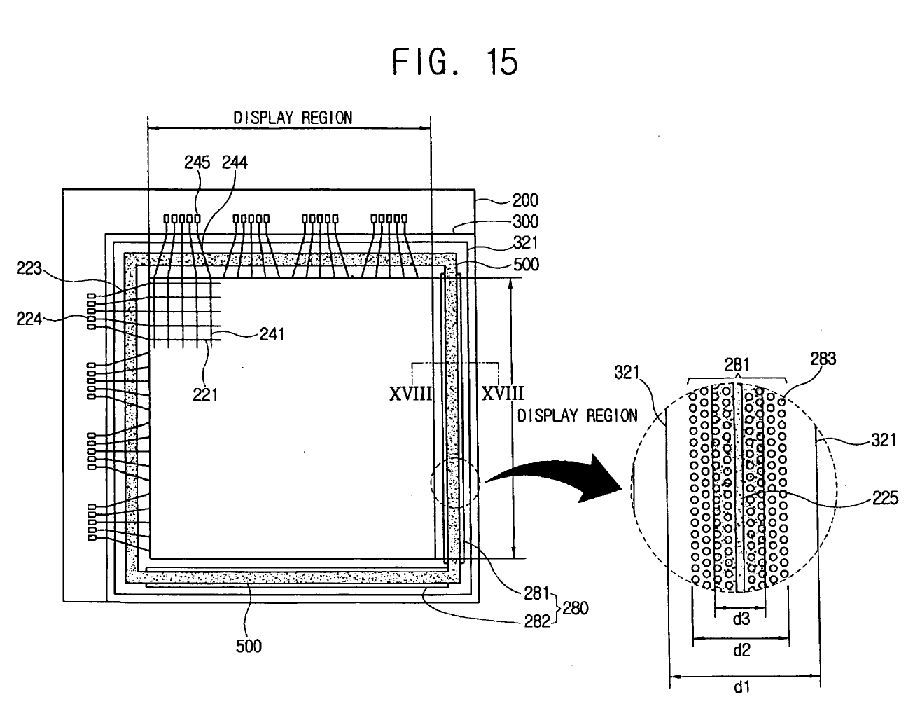

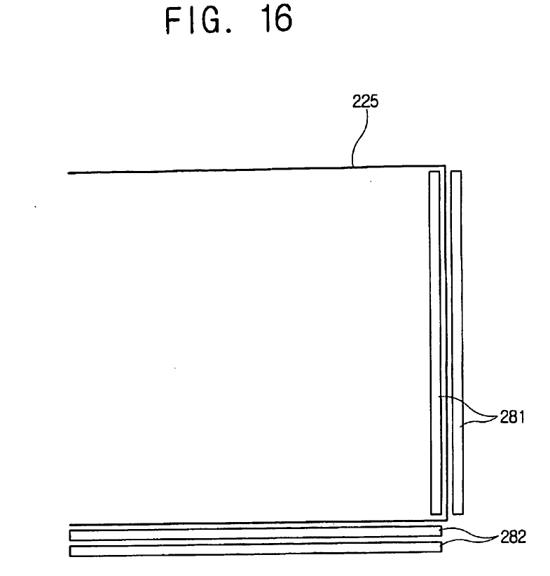

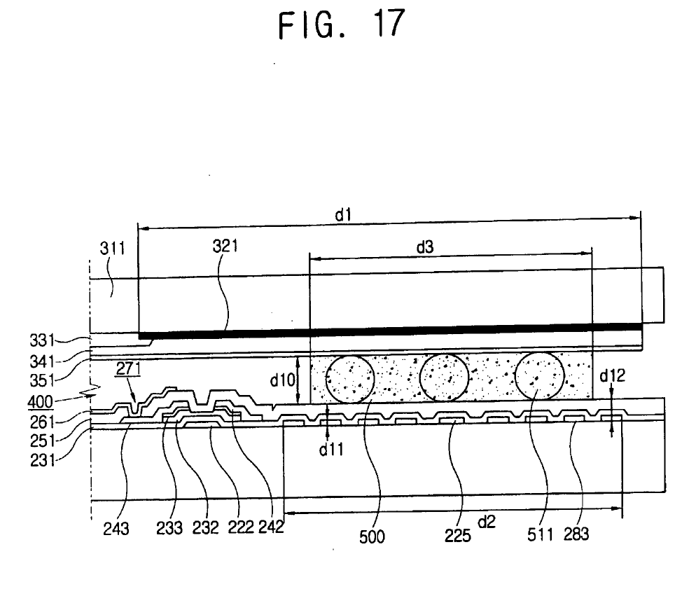

Below, an LCD according to a tenth embodiment of the present invention will be described with reference to FIGS. 15 through 18.

Sometimes, a signal line such as a repair line can be formed along the circumference of the display region if desired. As the density of panel configuration has recently become high, the signal line approaches a corner of a substrate. Therefore, a problem arises in that the signal line is opened by static electricity. In the LCD according to the tenth embodiment of the present invention, the foregoing problem of the signal line being opened is diminished. Below, the repair line will be described as an example of the signal line according to the tenth embodiment of the present invention. However, it should be understood that the embodiment is not limited to being used for a repair line.

Along the circumference of the display region, the repair line 225 is formed on the same layer as the gate wiring lines 221, 222, 223, 224. The repair line 225 is provided between the display region and the data pad 245, a side opposite to the gate pad 224, and a side opposite to the data pad 225. Here, the repair line 225 is insulated from and intersects the data line 241 connected to the data pad 245, leaving the gate insulating layer 231 therebetween.

The repair line 225 passes through the inside of the first dummy metal patterns 281. For this, the first dummy metal pattern 281 is divided into two sections by the repair line 225. Likewise, the second dummy metal pattern 282 is also divided into two sections but the repair line 225 passes between the second dummy metal pattern 282 and the display region. In some alternative embodiments, the second dummy metal pattern 282 may not be divided into two sections.

The sealant 500 instead of the liquid crystal layer 400 is provided between the repair line 225 placed inside the first dummy metal pattern 281 and the common electrode 351. If the liquid crystal layer 400 is placed between the repair line 225 and the common electrode 351, there is a resistance and capacitance (RC) delay due to a high dielectric constant, thereby causing a defect in driving the LCD.

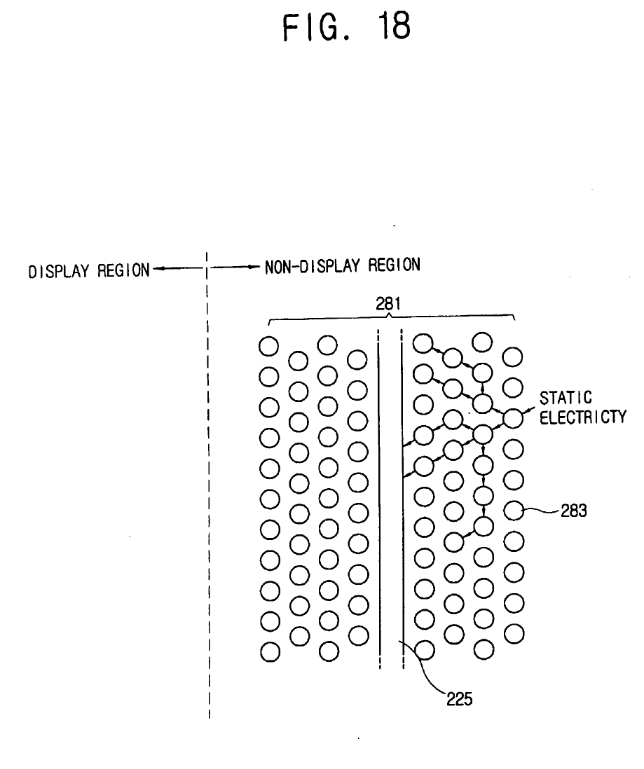

FIG. 18 is a view illustrating an electrostatic phenomenon arising in the dummy metal pattern 281 in the LCD in the case where the repair line 225 according to the tenth embodiment of the present invention is provided. External static electricity may be applied to the dots 283 of the dummy metal pattern 281. In this case, the static electricity is transferred to the neighboring dots 283. Thus, the static electricity is dispersed through many dots 283 and prevented from reaching the display region. Even in cases where some electricity reaches the display region, the amount that reaches the display region is very weak. Therefore, the repair line 225 is protected from the external static electricity. Also, the dots 283 are provided between the repair line 225 and the display region, thereby preventing the static electricity from being applied to the display region.

The foregoing embodiments may vary. For example, the first dummy metal pattern 281 may be asymmetrically divided into two sections. Further, the first dummy metal pattern 281 may be provided as a data metal layer, or may be provided as a double layer of a gate metal layer and the data metal layer.

Further, the foregoing embodiments can be used in various combinations. For example, the first dummy metal pattern 281 may have the dot shape 283, 284 in one region (e.g., a region near the display region) and have the line shape 285, 286 in another region (e.g., a region distant from the display region). Further, the first dummy metal pattern 281 and the second dummy metal pattern 282 can be shaped differently from each other. Also, in some embodiments, only one of the first dummy metal pattern 281 and the second dummy metal pattern 282 may be provided.

As described above, the present invention provides an LCD comprising a uniform cell gap and a method of fabricating the same.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An LCD comprising:
a first panel comprising a pad provided in a first part of a non-display region and a dummy metal pattern provided in a second part of the non-display region, wherein the first part and the second part lie along a circumference of a display region;
a second panel;
a sealant formed on the pad and the dummy metal pattern and coupling the first panel with the second panel; and
a liquid crystal layer provided between the first panel and the second panel.

2. The LCD according to claim 1, wherein the sealant comprises a spacer including plastics.

3. The LCD according to claim 1, wherein the sealant comprises a spacer that is deformed by 5% or more in a direction of a force when the force of about 500 kg/mm² is applied to the spacer at a room temperature.

4. The LCD according to claim 1, wherein the dummy metal pattern has a width wider than a width of the sealant.

5. The LCD according to claim 1, wherein the dummy metal pattern includes a plurality of dots.

6. The LCD according to claim 5, wherein the dots are arranged in five or more rows.

7. The LCD according to claim 5, wherein a distance between the dots ranges from about 5 μm to about 15 μm.

8. The LCD according to claim 5, wherein at least some of the dots have either a circular cross-section or a polygonal cross-section.

9. The LCD according to claim 5, wherein at least some of the dots have a diameter ranging from about 15 μm to about 40 μm.

10. The LCD according to claim 5, wherein the dots are arranged to have a density ranging from 40% to 60%.

11. The LCD according to claim 1, wherein the second panel comprises an outer black matrix arranged along the sealant.

12. The LCD according to claim 1, wherein the dummy metal pattern comprises a line pattern arranged parallel to the circumference of the display region.

13. The LCD according to claim 1, wherein the dummy metal pattern comprises a line pattern arranged at a predetermined angle to the circumference of the display region.

14. The LCD according to claim 1, wherein the pad comprises a gate pad and a data pad, and
the dummy metal pattern is formed of the same layer as either the gate pad or the data pad.

15. The LCD according to claim 1, further comprising a signal line at least partially placed inside the dummy metal pattern.

16. The LCD according to claim 15, wherein the pad comprises a gate pad and a data pad,
the dummy metal pattern comprises a first dummy metal pattern across the display region from the gate pad, and a second dummy metal pattern across the display region from the data pad, and
the signal line is partially placed inside the first dummy metal pattern.

17. The LCD according to claim 15, wherein the first panel comprises a gate line and a data line arranged at an angle relative to each other and insulated from each other, and
the signal line is insulated from and positioned at an angle with respect to the data line.

18. The LCD according to claim 15, wherein the signal line comprises a repair line.

19. An LCD comprising:
a first panel comprising a display region defined by a gate line and a data line;
a second panel opposite the first panel;
a sealant formed along a circumference of the display region and coupling the first panel with the second panel;
a liquid crystal layer provided between the first panel and the second panel; and
a dummy metal pattern provided on either the first panel or the second panel and uniformizing the height of the sealant.

20. A method of fabricating an LCD, comprising:
providing a first panel comprising a pad provided in a first part of a non-display region and a dummy metal pattern provided in a second part of the non-display region along a circumference of a display region;
providing a second panel;
forming a sealant on either the first panel or the second panel along the pad and the dummy metal pattern; and
filling liquid crystal between the first panel and the second panel and coupling the first panel with the second panel.

21. The method according to claim 20, wherein the pad comprises a gate pad, and the dummy metal pattern is formed in the same process step as the gate pad.

22. The method according to claim 20, wherein the pad comprises a data pad, and the dummy metal pattern is formed in the same process step as the data pad.

23. The method according to claim 20, wherein the dummy metal pattern includes dots.
